(19) United States
(12) Patent Application Publication
(10) Pub. No.: US 2013/0117988 A1
(43) Pub. Date: May 16, 2013

(54) MANNEQUIN NECK CONNECTION FITTING COMPONENT AND METHOD OF MAKING SAME

(71) Applicant: Susan Jane Heffernan, Shanghai (CN)

(72) Inventor: Susan Jane Heffernan, Shanghai (CN)

(21) Appl. No.: 13/605,944

(22) Filed: Sep. 6, 2012

Related U.S. Application Data
(60) Provisional application No. 61/558,401, filed on Nov. 10, 2011.

(51) Int. Cl. A47F 8/00; A41H 5/00; F16B 17/00; B23P 11/00; B29C 67/00

(52) U.S. Cl. 29/428; 403/164; 264/239; 403/345

(57) ABSTRACT

A mannequin neck connection fitting component for interconnecting a mannequin head on a mannequin body is disclosed. The component includes a mannequin head engaging tubular part adapted to be affixed to and depend from a mannequin head. A mannequin body engaging tubular part is adapted to be affixed within an opening in an upper portion of a mannequin body. The component parts inter-engage telescopically to support the mannequin head on top of the mannequin body in a removable manner.

### RELATED PATENT APPLICATION

This application claims priority to U.S. provisional patent application, Ser. No. 61/558,401, filed Nov. 10, 2011, entitled MANNEQUIN NECK CONNECTION FITTING COMPONENT AND METHOD OF MAKING SAME, which is incorporated herein by reference in its entirety.

### FIELD OF THE INVENTION

The present invention relates to a connection component between a mannequin head and a mannequin body, and method of making the component. It more particularly relates to a new and improved two part connection fitting component and method to facilitate the manufacturing of mannequins on a large scale basis.

### BACKGROUND ART

This section describes the background art of the disclosed embodiment of the present invention. There is no intention, either express or implied, that the background art discussed in this section legally constitutes prior art.

Currently, mannequins are largely made by hand and are formed from suitable material such as plaster. Conventionally, the connection method between a mannequin head and a mannequin body is to extend manually the material used in the head to form a neck shape. Then this integral neck portion (which is an integral part of the head) may be inserted directly into a hole at the top of the body.

However, this neck portion which extends from the head to form a neck has a critical dimension requirement for its circumference. If the circumference at the neck portion is different from the circumference of the hole in the body, then the mannequin head may not be attached conveniently to the mannequin body. It is difficult to control the quality and fit because most of the work has been conventionally done by manual labor. This means that every mannequin neck and body may vary somewhat in size.

If the circumference of the neck portion is smaller than the hole in the body, then the head and the mannequin may not be sufficiently stable when interconnected. If the neck portion circumference is larger than the size of the hole in the body, then the head may not be able to be attached to the body.

The above two situations may give rise to an unwanted waste of raw material and labor because in many cases the head or the body part may require being re-worked or re-made. It also means that if a mannequin head is damaged or requires replacement or to be interchanged for another color or style (in the conventional method of production), the body would also require replacement.

In the prior known method of production there is little reason to believe, and there is no assurance, that the neck will fit accurately into the body opening. Currently, the technique relies on manual labor. This manual labor technique is difficult to control the accuracy and requires more labor for the production department to make certain that the head part and body part dimensions fit securely together. Such manual operations do not at all lend itself to modern mass production techniques.

### BRIEF DESCRIPTION OF THE DRAWINGS

In order to better understand the invention and to see how the same may be carried out in practice, non-limiting preferred embodiments of the invention will now be described with reference to the accompanying drawings, in which:

FIG. 1 is a pictorial view of a mannequin neck connection component, which is constructed in accordance with an embodiment, and which is illustrated in the process of attaching a mannequin head to a mannequin body;

FIG. 2 is a pictorial enlarged view of the head part of the component secured to the mannequin head with portions thereof broken away for illustration purposes and being illustrated in being assembled;

FIG. 3 is a pictorial view of the body part of the neck connection component secured to the mannequin body;

FIG. 4 is a pictorial view of the mannequin head secured to the mannequin body using the component (not shown) of FIG. 1;

FIG. 5 is an enlarged pictorial view of the mannequin head part of the component of FIG. 1;

FIG. 6 is a bottom view of the head part of FIG. 5;

FIG. 7 is a top view of the head part of FIG. 5;

FIG. 8 is a vertical sectional view of the mannequin head part of the component of FIG. 5;

FIG. 9 is an enlarged pictorial view of the mannequin body part of the component of FIG. 1;

FIG. 10 is a bottom view of the body part of FIG. 9;

FIG. 11 is a top plan view of the body part of FIG. 9; and

FIG. 12 is a vertical sectional view of the body part of FIG. 9.

### CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of certain ones of the embodiments of the device, system and method of the present invention, as represented in the drawings, is not intended to limit the scope of the invention, as claimed, but is merely representative of the embodiments of the invention.

A mannequin neck connection fitting component for interconnecting a mannequin head on a mannequin body is disclosed. The component includes a mannequin head engaging tubular part adapted to be affixed to and depend from a mannequin head. A mannequin body engaging tubular part is adapted to be affixed within an opening in an upper portion of a mannequin body. The component parts inter-engage telescopically to support the mannequin head on top of the mannequin body in a removable manner.

According to an embodiment, a mannequin neck connection fitting component is disclosed for interconnecting removably a mannequin head and a mannequin body. The component includes a mannequin head engaging tubular part having an integrally connected inner tubular member for engagement telescopically with a body engaging part of the component. The inner member is generally in the shape of an inverted cup and having a top wall adapted to be fastened to the bottom of the mannequin head. The inner member is spaced from the tubular part outer wall to enable the outer wall to flex inwardly when manual pressure is applied during insertion or removal from the body engaging part. The tubular part outer wall is tapered and is adapted to interconnect telescopically with the mannequin body engaging tubular part fastened to the mannequin body. The body engaging tubular part has an outer tapered wall, which is complementary shaped relative to the head engaging part outer wall so that the head engaging part and the body engaging part can fit telescopically securely together to support the mannequin head on the mannequin body in a removable and rotatable manner.

A method according to an embodiment enables a mannequin neck connection component to be made by fastening a top closed end wall of a tubular head engaging part to the bottom of a mannequin head. A tubular body engaging part is secured within a complementary shaped opening in the top portion of a mannequin body. The two parts are inter-fitted telescopically together.

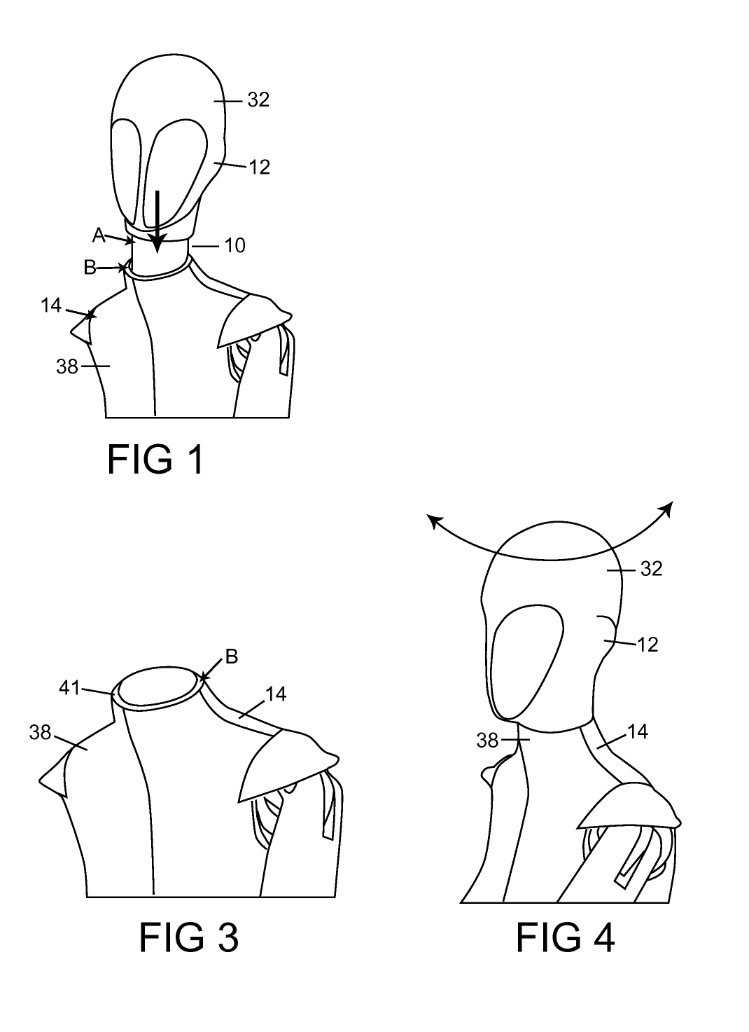

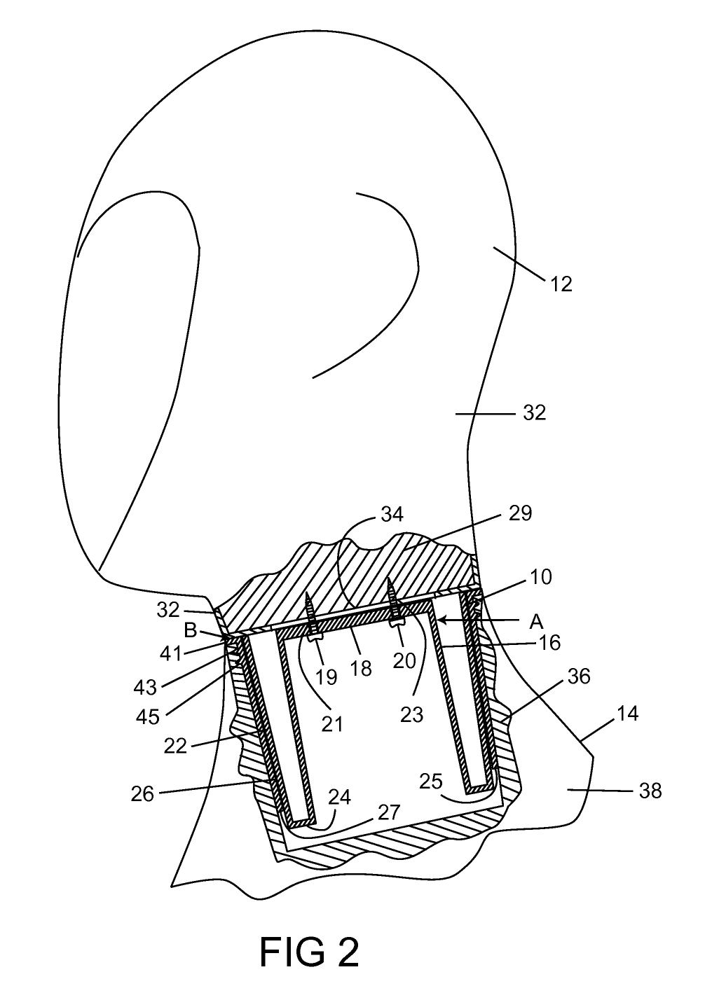

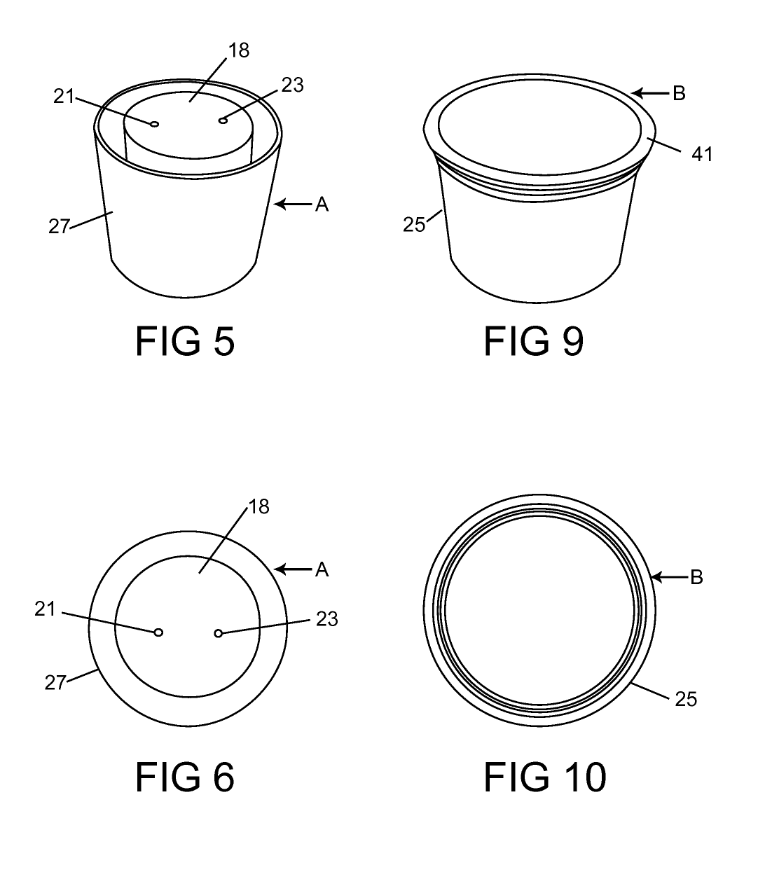

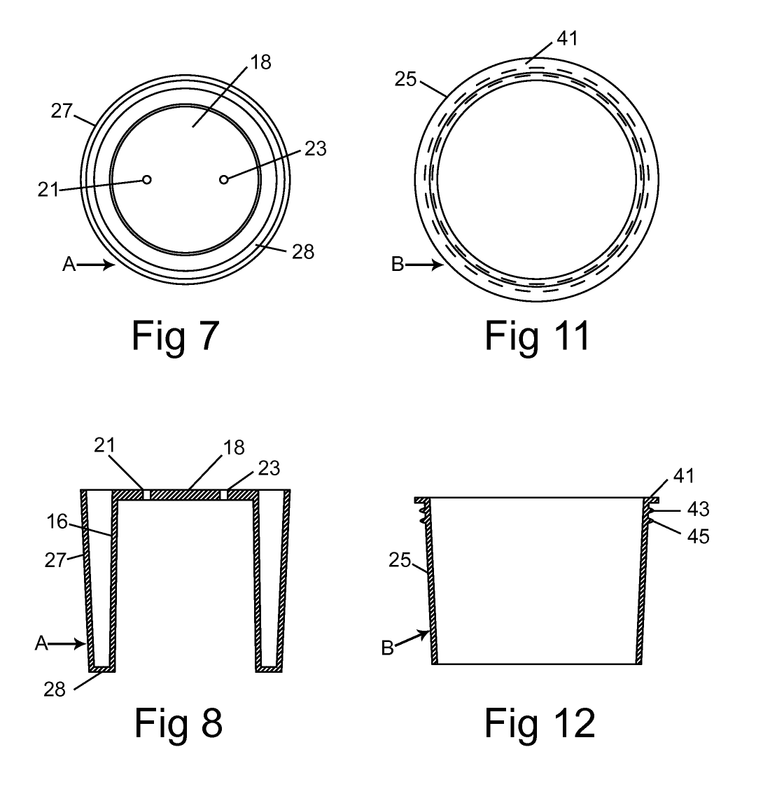

Referring now to the drawings, and more particularly to FIGS. 1-4, there is shown a two-part mannequin neck connection fitting component 10, as best seen in FIG. 2, which is constructed in accordance with an embodiment, and which enables a mannequin head 12 to be connected to a mannequin body 14. In this manner, the mannequin head 12 is easily and readily attachable and removable from mannequin body 14. Also, the mannequin head 12 may be readily rotatable about an upright axis to an adjusted position relative to the mannequin body 14.

The two-part component 10 enables the manually made mannequin head 12 and body 14 to be interconnected perfectly, since the dimensions of the two component parts are each consistent dimensionally since they may both be molded to close tolerances. Using the component 10, the head 12 may be mounted on the body 14 in a secure and stable manner, and yet the head 12 may be readily rotated to an adjusted position or may be removed from the body 14 to be replaced with another like mannequin head (not shown).

Considering now the component 10 in greater detail, the component 10 comprises a part A interconnectable with a part B. The part A may be generally cylindrical in shape and generally circular throughout its axial length. The part A may have an inverted cup shaped inner tubular member 16, which is disposed concentrically within and spaced from an outer wall 22 of the part A by an annular flange or web portion 24. The member 16 may have an inverted cup shape and may be integrally connected to the outer tubular wall 27 at the bottom thereof. A top wall 18 of the inner tubular member 16 may be fixedly secured to the bottom of the mannequin head 12 by a pair of fasteners such as screws 19 and 20 extending through a pair of screw holes 21 and 23 to facilitate fixing the part A to the mannequin head 12. The top circular wall has a thickness which may be substantially greater than the thickness of the outer wall 27 to have a substantial member for securing the part A to the head 12.

The inner tubular member 16 may be spaced from the tubular part outer wall 27 to enable the outer wall 27 to flex inwardly when manual pressure is applied to facilitate enabling the part A to be inserted snugly and frictionally into the part B in a stable manner and yet may be removed therefrom to place another mannequin head (not shown) on top of the body 14. The outer wall 27 may be tapered and narrows slightly from its top to its bottom to facilitate the inter-engagement of the two parts A and B.

Considering now the mannequin body engaging part B in greater detail, the part B may include a tapered cylindrical hollow tubular outer wall 25, which may be adapted to be fastened fixedly to the mannequin body 14 within an opening 26 (FIG. 2) in the upper portion thereof. The tubular wall 25 may be tapered and complementary shaped relative to the head engaging part outer wall 27 so that the head engaging depending part A and the body engaging part lining the body opening 26 may fit telescopically together to support the mannequin head 12 on the upper portion of the mannequin body 14 in a stable secure manner and yet in a removable and rotatably adjustable manner.

Considering now the mannequin head 12 in greater detail, the head 12 includes a head form 29, which may be formed in the shape of a human head from suitable material such as plaster or other material. A fabric covering 32 may be disposed over the head form 29 to finish the appearance cosmetically of the head 12. The fabric covering 29 closely conforms to the head form 29 and is drawn together at the underside to leave a fabric covering opening generally indicated at 34 as best seen in FIG. 2.

Considering now the body 14 in greater detail with particular reference to FIG. 2, the body 14 may include a body form which may be molded by hand from suitable material such as plaster or other such material. A fabric covering 38 may be employed over the body form 36 in a similar manner as the optional fabric covering 32 for the head 12.

Considering further the part B, the part B may include a top annular rim 41 which overlies the top portion of the body 14 surrounding the opening to the body opening 26. A pair of annular outer ridges 43 and 45 are disposed slightly below the top annular rim 41 to help anchor the part B to the body form 36 of the body 14.

According to a method of an embodiment, both the part A and the part B of the mannequin neck connection fitting component 10 may each be made in one piece by molding them of suitable thermoplastic material. Thus, both the head engageable part A and the body engaging part B may be manufactured in one piece by forming them of suitable thermoplastic material.

The present embodiment overcomes the disadvantage of the current technique, which relies on manual labor, for at least some applications. The component 10 between the mannequin head and body may be manufactured by machine in high volumes, and thus may be relatively inexpensive to manufacture. An embodiment of the detailed method is to make a mold of the component parts so that the parts may be made to the same or similar dimensions. This new embodiment may avoid the loss of raw material to fit together consistently and repeatedly the head and body of a mannequin. The component 10 may be manufactured in large volumes. It also saves cost and allows the user to readily interchange heads and bodies of different types and colors.

Considering an embodiment of a method of using the component 10, firstly concept drawings (not shown) may be prepared followed by detailed design and manufacturing design drawings (not shown). The component parts A and B may then be manufactured by using suitable molds (not shown). The connecting fitting component 10 may be produced in plastic material.

The part A and part B may be attached to the head 12 and the body 14 respectively and then part A is inserted into part B to mount the head 12 on the body 14 in a stable and rotatable manner. By utilizing the component 10, it may not be necessary to lengthen the neck part of the head 12 as done according to the prior art methods. The part of the head which was conventionally extended to form a neck can be replaced by part A.

Part A may be set into the top part of the body 14 which provides an opening in Part B to receive fixedly part A. The dimension of part A may be designed to fit consistently snugly and frictionally into the dimension of part B.

At least one of the benefits of the component 10 may be for certain applications that it enables the head 12 to be rotated positionally about an upright axial relative to the body 14 to an adjustably rotatable position of the mannequin head 12 on the body 14 in a convenient manner. Compared with the previous conventional method of connection, this new method saves on raw material, labor and production time. It also may ensure that every mannequin head such as the head 12 may easily be fitted into and removably and adjustably attached to a body such as the body 14.

Part B may be inserted into the body opening 26 (FIG. 2) and may be secured in place by a suitable adhesive such as a glue, epoxy or other into the body 14. Part A may be attached by fasteners such as screws or other devices to affix the part A to the bottom of the head 12 so that it is protruding therefrom. The tapered circumferences of part A and part B may be designed so that they fit telescopically smoothly and securely together. Part A may be hollow with the inner tubular member 16 disposed concentrically in order to give the outer wall 27 flexibility to fit smoothly and readily into part B in a secure manner releaseably, and yet the head 12 may be rotated positionally or removed conveniently due to the flexible part A.

In summary, part A may be the part that is joined into the bottom of the head 12 and it replaces the previous conventional production manual method which formed manually the neck portion of the mannequin as an integral non-rotatable fixed part of the head. Part B may be fixed into the body 14 during the production and the dimensions of part B and of part A enables the parts A and B to fit together consistently.

Part A and part B may each be tapered to make it much easier for the head 12 to turn left and right and rotate relative to the body 14. The mannequin head 12 may be positioned with more stability.

The weight of the component 10 may be relatively light, and the cost to manufacture may be relatively less expensive.

The top and bottom ends of part B may be open. During the production of the body part B, it may be inserted into and affixed onto the top of the body 14.

While particular embodiments of the present invention have been disclosed, it is to be understood that various different modifications and combinations are possible and are contemplated within the true spirit and scope of the disclosed embodiments. There is no intention, therefore, of limitations to the exact disclosure herein presented.

What is claimed is:

1. A mannequin neck connection fitting component for interconnecting removably a mannequin head and a mannequin body, comprising:
a mannequin head engaging tubular part having an integrally connected inner tubular member;
the inner member being generally inverted cup shaped and having a top wall adapted to be fastened to the bottom of the mannequin head;
the inner member being spaced from the tubular part outer wall to enable the outer wall to flex inwardly when manual pressure is applied;
the tubular part outer wall being tapered;
a mannequin body engaging tubular part adapted to be fastened to the mannequin body; and
the body engaging tubular part having an outer tapered wall being complementary shaped relative to the head engaging part outer wall so that the head engaging part and the body engaging parts can fit telescopically together to support the mannequin head on the mannequin body in a removable and rotatable manner.

2. A method of making a mannequin neck connection fitting component of claim 1, comprising:
forming the head engaging portion of thermoplastic material; and
forming the body engaging portion of thermoplastic material.

3. A mannequin neck connection fitting component according to claim 2, wherein the inner member includes an outer tubular wall having an integral top wall for fixing to the bottom of the head.

4. A mannequin neck connection fitting component according to claim 3, wherein the head-engaging part further includes an annular web portion integrally connected between the bottom of the tubular wall and the bottom of the inner member.

5. A mannequin neck connection fitting component according to claim 4, wherein the top wall includes a plurality of holes for receiving fasteners to join fixedly the top wall to the mannequin head.

6. A mannequin neck connection fitting component according to claim 5, wherein the body engaging tubular part includes a top annular rim to overlie an opening in the upper portion of the body.

7. A mannequin neck connection fitting component according to claim 6, wherein the body engaging tubular part includes a plurality of annular outer ridges to engage the body securely.

8. A mannequin neck connection fitting component, comprising:
a mannequin head engaging tubular part adapted to be affixed to and depend from a mannequin head;
a mannequin body engaging tubular part adapted to be affixed within an opening in an upper portion of a mannequin body; and
wherein the parts inter-engage telescopically to support the mannequin head on top of the mannequin body in a removable manner.

9. A mannequin neck connection fitting component according to claim 8, wherein the parts can rotate axially when telescopically inter-engaged.

10. A method of making a mannequin neck connection fitting component, comprising:
fastening a top partially closed end wall of a tubular head engaging part to the bottom of a mannequin head;
securing a tubular body engaging part within a complementary shaped opening in the top portion of a mannequin body; and
telescopically inter-fitting the parts together.
